(19) United States
(12) Patent Application Publication
(10) Pub. No.: US 2010/0184436 A1
(43) Pub. Date: Jul. 22, 2010

(54) Radio Base Station and Radio Communication Method

(75) Inventor: Hitoya Tachikawa, Yokohama (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/593,242

(22) PCT Filed: Mar. 24, 2008
(86) PCT No.: PCT/JP2008/055473

§ 371 Date: Mar. 15, 2010

(30) Foreign Application Priority Data
Mar. 27, 2007 (JP) 2007-082861

(51) Int. Cl. H04W 36/34

(52) U.S. Cl. 455/436

(57) ABSTRACT

A radio base station according the present invention communicates with a radio communication terminal which has established a connection. The radio base station includes: a task manager 131 configured to acquire communication capability information indicating processing capability of CPU; a load judging unit 132 configured to judge whether or not the communication capability information falls below a threshold; and a packet generator 134 and a communication processor 135 configured to transmit MOB_BSHO_REQ message requesting switching of a connection destination to a different radio base station to at least one of the radio communication terminals if judged that the communication capability information falls below the threshold.

### TECHNICAL FIELD

The present invention relates to a radio base station and a radio communication method for communicating with a radio communication terminal which has established a connection.

### BACKGROUND ART

Generally, in a radio communication system, a radio communication terminal on the move performs a handover to switch its connection destination to a radio base station having a better condition. Specifically, a radio communication terminal makes a comparison of the received powers of broadcast signals broadcasted by multiple radio base stations, and then switches its connection destination to a radio base station from which the highest received power is obtained.

In such a radio communication system, a large number of radio communication terminals located around one radio base station may connect to the radio base station at the same time. In this case, the usage rate of a hardware resource, such as a MY or a memory, provided to the radio base station reaches its limit value (near 100%), so that the capability of the radio base station to communicate with each radio communication terminal (hereinafter, referred to as “communication capability”) is deteriorated.

There has been proposed a technique to equalize processing loads among multiple radio base stations (see Patent Document 1). Specifically, when receiving a connection request from a radio communication terminal, a radio base station delays the time to a respond to the connection request by a period of time proportional to the processing load on the radio base station. The radio communication terminal connects to a radio base station which has made the quickest response to the connection request.

### Patent Document 1: JP-A 5-235845 (P. 9, FIG. 11).

### DISCLOSURE OF THE INVENTION

In the technique in Patent Document 1, the processing load on a radio base station is considered only in the period in which the radio base station receives a connection request from a radio communication terminal. In other words, no measure is taken in Patent Document 1 to a case where the usage rate of a hardware resource of the radio base station reaches its limit value after a connection is established between the radio base station and RD the radio communication terminal. For this reason, it is impossible to sufficiently prevent a deterioration of the communication capability caused when the usage rate of the hardware resource of the radio base station reaches the limit value.

The present invention has been made in view of the above problem, and an object thereof is to provide a radio base station and a radio communication method which are capable of more reliably preventing a deterioration of the communication capability caused when the usage rate of a hardware resource of a radio base station reaches its limit value. To accomplish the object above, a first characteristic of the present invention is summarized as a radio base station (radio base station 100A) that communicates with radio communication terminals (radio communication terminal 200A, radio communication terminal 200B, and radio communication terminal 200C), and the radio base station includes: an acquiring unit (task manager 131) configured to acquire communication capability information while the radio base station is connected to the radio communication terminals, the communication capability information indicating a capability to communicate with the radio communication terminals (processing capability of CPU 130, for example); a judging unit (load judging unit 132) configured to judge whether or not the communication capability information acquired by the acquiring unit falls below a threshold; and a transmitter (packet generator 134 and communication processor 135) configured to transmit a switching request to at least one of the radio communication terminals (radio communication terminal 200B) if the judging unit judges that the communication capability information falls below the threshold, the switching request (MOB_BSHO_REQ message) requesting switching of a connection destination to a different radio base station (radio base station 100B).

According to the above-described characteristic, the radio base station transmits a switching request requesting switching of a connection destination to a different radio base station, to at least one radio communication terminal if judging that the communication capability information falls below a threshold.

Accordingly, when the usage rate of a hardware resource of the radio base station reaches a limit value and thus the communication capability is deteriorated to the threshold, the radio base station reduces the number of radio communication terminals currently connected thereto. Consequently, it is possible to more reliably prevent a deterioration of the communication capability caused when the usage rate of the hardware resource of the radio base station reaches a limit value.

A second characteristic of the present invention is according to the first characteristic of the present invention, and is summarized in that the radio base station includes: a corrector (radio communication unit 120 and communication processor 135) configured to correct a timing at which a radio signal is transmitted from each of the radio communication terminals and a timing at which a radio signal is transmitted to each of the radio communication terminals; and a selector (terminal selector 133) configured to select a predetermined number of the radio communication terminals in order starting from the greatest value of correction amounts of timings, on the basis of a table (ranging value table) in which each of the radio communication terminals is associated with each of the correction amounts of the timings (ranging value), wherein the transmitter transmits the switching request to each of the radio communication terminals selected by the selector.

A third characteristic of the present invention is according to the first characteristic of the present invention, and is summarized in that the radio base station includes a selector (terminal selector 133) configured to select a predetermined number of the radio communication terminals in order starting from the smallest value of service quality information, on the basis of a table (service class table) in which each of the radio communication terminals is associated with the service quality information (service class) indicating quality of a a communication service provided to each of the radio communication terminals, wherein the transmitter transmits the switching request to each of the radio communication terminals selected by the selector.

A fourth characteristic of the present invention is according to the first characteristic of the present invention, and is summarized in that the radio base station includes a selector (terminal selector 133) configured to select a predetermined number of the radio communication terminals in order starting from the smallest value of priority information, on the basis of a table (QoS table) in which each of the radio communication terminals is associated with the priority information (QoS) indicating a priority corresponding to a type of communication performed by each of the radio communication terminals, wherein the transmitter transmits the switching request to each of the radio communication terminals selected by the selector.

A fifth characteristic of the present invention is according to the first characteristic of the present invention, and is summarized in that the radio base station includes a selector (terminal selector 133) configured to select a predetermined number of the radio communication terminals in order starting from the greatest value of lengths of time elapsed after each of the radio communication terminals terminates its communication, on the basis of a table (communication status table) in which each of the radio communication terminal is associated with each of the lengths of time elapsed, wherein the transmitter transmits the switching request to each of the radio communication terminals selected by the selector.

A sixth characteristic of the present invention is according to the second to the fifth characteristics of the present invention, and is summarised in that the radio base station includes a communication unit (I/F unit 150) configured to communicate with a terminal management server (terminal management server 400) that manages the radio communication terminals, wherein the table is stored in the terminal management server.

A seventh characteristic of the present invention is according to the sixth characteristic of the present invention, and is summarized in that the communication unit receives base station identifying information identifying the different radio base station, from the terminal management server, and the transmitter transmits the switching request including the base station identifying information.

An eighth characteristic of the present invention is summarized as a radio communication method for a radio base station that communicates with radio communication, terminals, and the radio communication method includes the steps of: acquiring communication capability information while the radio base station is connected to the radio communication terminals, the communication capability information indicating a capability to communicate with, the radio communication terminals; judging whether or not the communication capability information acquired in an acquisition step falls below a threshold; and transmitting a switching request to at least one of the radio communication terminals if it is judged in a judging step that the communication capability information falls below the threshold, the switching request requesting switching of a connection destination to a different radio base station.

According to the present invention, it is possible to provide a radio base station and a radio communication method which are capable of more reliably preventing a deterioration of the communication capability caused when the usage rate of a hardware resource of the radio base station reaches a limit value.

### BRIEF DESCRIPTION OF THE DRAWINGS

FIG. 1 is a schematic configuration diagram of a radio communication system according to a first embodiment of the present invention.

FIG. 2 is a schematic configuration diagram of hardware of a radio base station according to the first embodiment of the present invention.

FIG. 3 is a functional block diagram of a CPU and a memory shown in FIG. 2.

FIG. 4 shows an example of a ranging value table stored in a terminal information storage unit of the radio base station according to the first embodiment of the present invention.

FIG. 5 is a sequence diagram showing an operation of the radio communication system according to the first embodiment of the present invention.

FIG. 6 is a schematic configuration diagram of a radio communication system according to a second embodiment of the present invention.

FIG. 7 is a schematic configuration diagram of a terminal management server according to the second embodiment of the present invention.

FIG. 8 shows an example of a service class table stored in a terminal information storage unit of the terminal management server according to the second embodiment of the present invention.

FIG. 9 is a sequence diagram showing an operation of the radio communication system according to the second embodiment of the present invention.

FIG. 10 shows an example of a QoS table according to one of other embodiments of the present invention.

FIG. 11 shows an example of a communication status table according to one of the other embodiments of the present invention.

FIG. 12 shows an example of a table indicating the number of connected terminals according to one of the other embodiments of the present invention.

FIG. 13 shows an example of a nearest base station table according to one of the other embodiments of the present invention.

### BEST MODES FOR CARRYING OUT THE INVENTION

Now, first and second embodiments of the present invention will be described with reference to the drawings. In the following descriptions of the drawings in the first and second embodiments, the same or similar components are denoted by the same or similar reference numerals.

### First Embodiment

### (1) Schematic Configuration of Radio Communication System

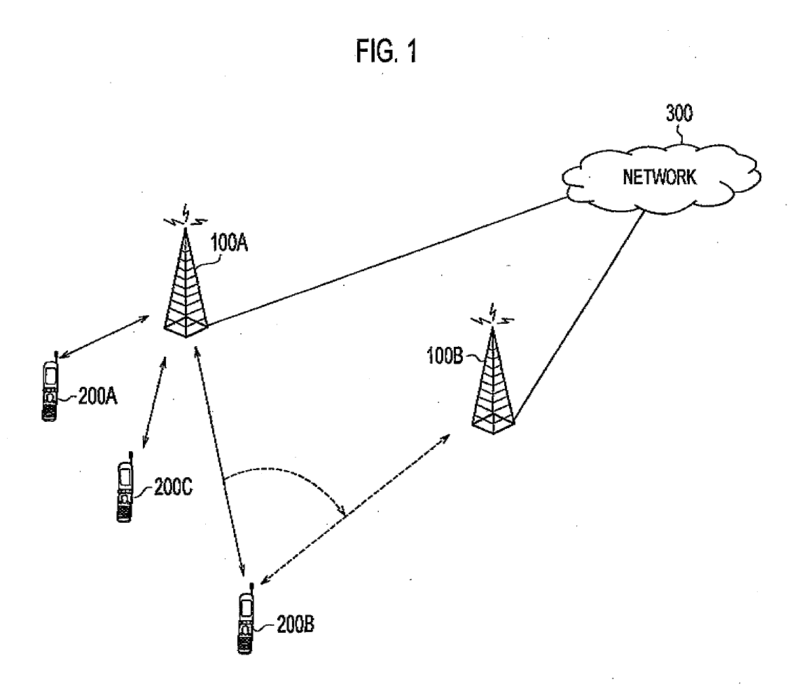

To begin with, a schematic configuration of a radio communication system according to this embodiment will be described. FIG. 1 is a schematic configuration diagram of the radio communication system according to this embodiment. In this embodiment, the description will be given for a radio communication system based on mobile WiMAX (IEEE802.16e-2005 standard).

As shown in FIG. 1, the radio communication system according in to this embodiment includes a radio base station 100A, a radio base station 100B, a radio communication terminal 200A, a radio communication terminal 200B, and a radio communication terminal 200C. The radio base station 100A and the radio base station 100E are connected to a network (IF network) 300.

Each of the radio communication terminal 200A, the radio communication terminal 200B, and the radio communication terminal 200C has established a connection to the radio base station 100A, and is communicating with the radio base station 100A. As the radio communication terminal 200A, the radio communication terminal 200B, and the radio communication terminal 200C communicate with the radio base station 100A, the load on the radio base station 100A increases.

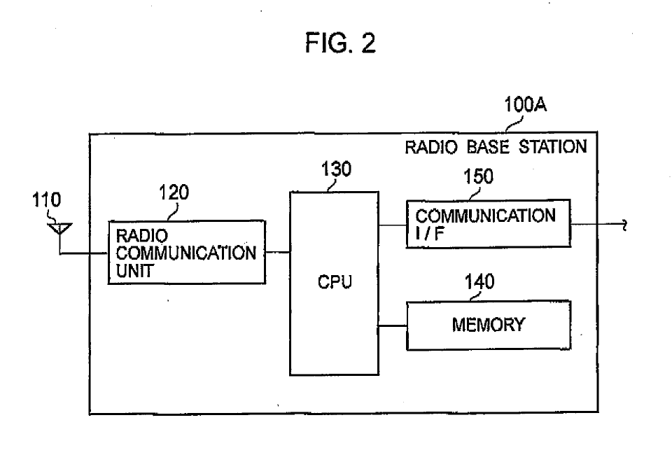

When detecting that the load has reached a limit value, the radio base station 100A determines that it cannot continue to provide proper communication services. In this embodiment, the radio base station 100A determines that it cannot continue to provide proper communication services, when the processing load on a CPU 130 (see FIG. 2) of the radio base station 100A exceeds a predetermined value.

When the processing load on the CPU 130 exceeds the predetermined value, the radio base station 100A transmits a handover request to at least one of the radio communication terminal 200A, the radio communication terminal 200B, and the radio communication terminal 200C. The handover request requests switching of a connection destination to another radio base station (radio base station 100B in FIG. 1), and is called an MOB_BSHO_REQ message in mobile WiMAX.

In the example shown in FIG. 1, the radio base station 100A transmits a handover request to the radio communication terminal 200B. When receiving the handover request, the radio communication terminal 200E finds the radio base station 100B which is its handover destination, and then performs reconnection processing (re-entry processing) with the radio base station 100B.

### (2) Configuration of Radio Base Station

Next, a configuration of the radio base station 100A will be described. Since the radio base station 100B has the same configuration as the radio base station 100A has, a description thereof will be omitted. In the following, the description will be given mainly for a part that is related to the present invention.

### (2.1) Hardware Configuration of Radio Base Station

FIG. 2 is a schematic configuration diagram of hardware of the radio base station 100A. As shown in FIG. 2, the radio base station 100A includes an antenna 110, a radio communication unit 120, a CPU 130, a memory 140, and a communication I/F unit 150.

The radio communication unit 120 transmits and receives a radio signal via the antenna 110. In addition, the radio communication unit 120 converts the radio signal into a baseband signal, and transmits and receives the baseband signal to and from the CPU 130. The radio communication unit 120 includes an LNA, a power amplifier, an up converter, a down converter, and the like.

The communication I/F unit 150 functions as an interface is to the network 300.

The CPU 130 controls various kinds of functions included in the radio base station 100A. Functional blocks of the CPU 130 will be described below in detail.

The memory 140 stores various kinds of information used for a control and the like in the radio base station 100A. Functional blocks of the memory 140 will be described below in detail.

### (2.2) Functional Block Configuration of Radio Base Station

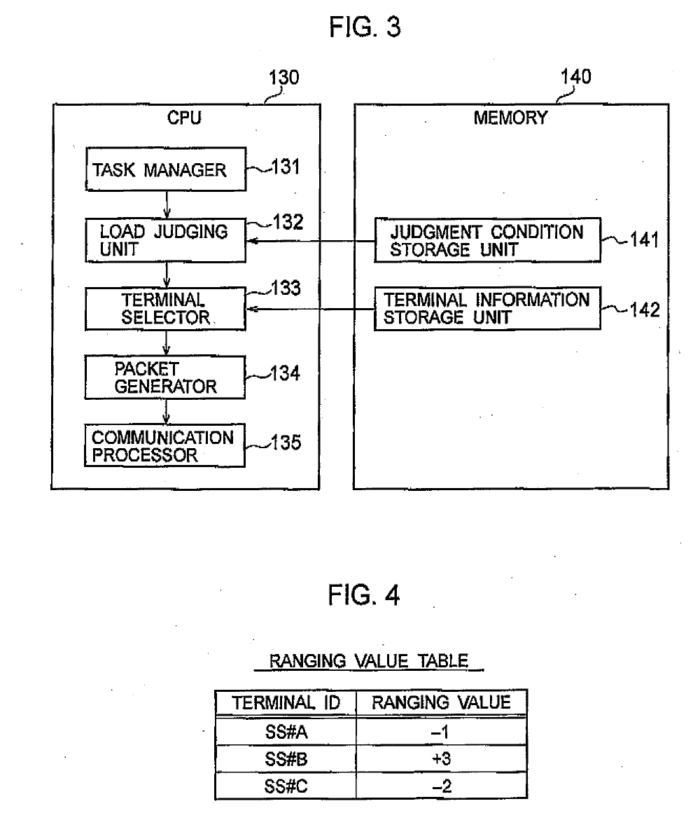

FIG. 3 is a functional block configuration diagram of the CPU 130 and the memory 140 shown in FIG. 2.

As shown in FIG. 3, the CPU 130 includes a task manager 131, a load judging unit 132, a terminal selector 133, a packet generator 134, and a communication processor 135. The memory 140 includes a judgment condition storage unit 141 and a terminal information storage unit 142.

The function of each of the task manager 131, the load judging unit 132, the terminal selector 133, the packet generator 134, and the communication processor 135 will be described below.

### (2.2.1) Task Manager

The task manager 131 manages the statuses of tasks running in the CPU 130, and also measures the processing load on the CPU 130. In this embodiment, a method of measuring idle-task processing time will be described as a method of measuring the processing load on the CPU 130.

An idle task is a task having the lowest execution priority, and is executed when no other tasks are running. Specifically, when the time for which the idle task is executed is not assigned at constant intervals, task transition in the CPU 130 is abnormal, and thus it is possible to judge that the load on the CPU 130 is increasing.

The task manager 131 periodically measures the time intervals at which the idle task is executed, and notifies the load judging unit 132 of the measured time

### (2.2.2) Load Judging Unit

The load judging unit 132 judges that the processing load on the CPU 130 has reached its limit, when the time intervals measured by the task manager 131 exceed a threshold. The threshold is stored in the judgment condition storage unit 141 in advance.

When the time intervals measured by the task manager 131 exceed the threshold, the load judging unit 132 specifies the number of radio communication terminals and sends the terminal selector 133 a notification requesting to select a radio communication terminal to which an MOB_BSHO_REQ message is to be transmitted.

### (2.2.3) Terminal Selector

In response to the notification from the load judging unit 132, the terminal selector 133 selects a radio communication terminal to which an MOB_BSHO_REQ message is to be transmitted. Specifically, the terminal selector 133 selects a radio communication terminal to which an MOB_BSHO_REQ message is to be transmitted, on the basis of information stored in the terminal information storage unit 142.

In this embodiment, the terminal information storage unit 142 stores a ranging value table indicating a result of ranging processing performed at the time of establishing a connection between the radio base station 100A and each radio communication terminal (radio communication terminal 200A, radio communication terminal 200B, and radio communication terminal 200C).

The ranging processing is processing for finely adjusting timings (phases) of transmitting radio signals in order to correct a transmission delay difference (phase error) corresponding to a distance between the radio base station 100A and each radio communication terminal.

The ranging processing will be specifically described by taking uplink communication as an example. The farther the radio base station 100A is from the radio communication terminal, the later the timing at which the radio base station 100A receives a radio signal. For this reason, a radio signal is set to be transmitted at an earlier timing from a radio communication terminal whose radio signal is received by the radio base station 100A at a timing later than a specified value. On the other hand, a radio signal is set to be transmitted at a later timing from a radio communication terminal whose radio signal is received by the radio base station 100A at a timing later than the specified value. The values thus set (hereinafter, called “ranging values”) are stored in the terminal information storage unit 142.

Accordingly, the terminal selector 133 selects a radio communication terminal having a larger ranging value, in other words, a radio communication terminal located farther from the radio base station 100A, as a destination to which the MOB_BSHO_REQ message is to be transmitted. If there exist multiple radio communication terminals to which the MOB_BSHO_REQ message is to be transmitted, the multiple radio communication terminals are selected in descending order of the ranging value.

The packet generator 134 is then notified of information on the radio communication terminal selected by the terminal selector 133.

### (2.2.4) Packet Generator

The packet generator 134 generates packets in a format following the mobile WiMAX protocols.

In addition, the packet generator 134 generates en MOB_BSHO_REQ message in response to the notification from the terminal selector 133.

### (2.2.5) Communication Processor

The communication processor 135 performs connection establishment processing and communication processing with the radio communication terminals (radio communication terminal 200A, radio communication terminal 200B, and radio communication terminal 200C).

The communication processor 135 transmits and receives packets generated by the packet generator 134 as well as other messages, data and the like, in units of frames. In addition, the communication processor 135 performs communication with the network 300 side via the communication I/F unit 150.

### (3) Ranging Value Table

Next, the ranging value table stored in the terminal information storage unit 142 will be described. FIG. 4 shows an example of the ranging value table stored in the terminal information storage unit 142.

As shown in FIG. 4, the terminal information storage unit 142 stores terminal IDs each uniquely identifying a radio communication terminal (radio communication terminal 200A, radio communication terminal 200B, and radio communication terminal 200C) and the above-described ranging values in association with each other.

In the example shown in FIG. 4, a terminal ID “$$#A” representing the radio communication terminal 200A is associated with a ranging value “−1.” A terminal ID “SS#B” representing the radio communication terminal 200B is associated with a ranging value “+3.” A terminal ID “ssf#C” representing the radio communication terminal 200C is associated with a ranging value “−2.” With such a ranging value table, the terminal selector 133 can determine that the radio communication terminal 200B is located farthest from the radio base station 100A.

### (4) Operation of Radio Communication System

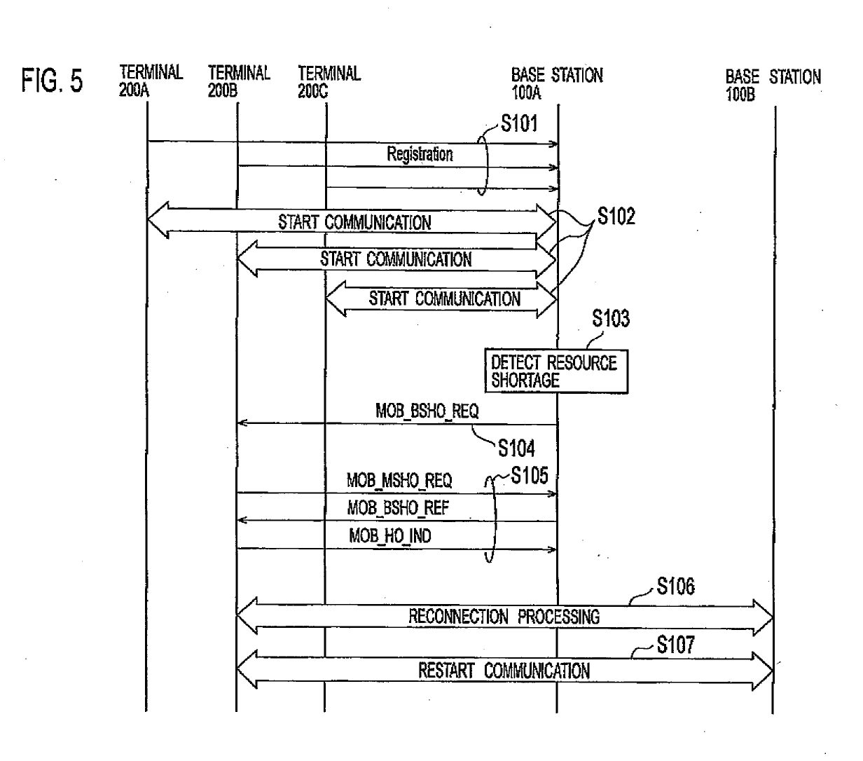

Next, an operation of the above-described radio communication system will be described. FIG. 5 is a sequence diagram showing the operation of the above-described radio communication system.

In Step S101, each of the radio communication terminal 200A, the radio communication terminal 200B, and the radio communication terminal 200C establishes a connection to the radio base station 100A. In this event, the radio base station 100A acquires a ranging value of each of the radio communication terminal 200A, the radio communication terminal 200B, and the radio communication terminal 200C.

In Step S102, each of the radio communication terminal 200A, the radio communication terminal 200B, and the radio Communication so terminal 200C starts communication with the radio base station 100A.

In Step S103, the radio base station 100A detects a resource shortage by using the above-described method. Specifically, the radio base station 100A judges that the processing load on the CPU 130 has exceeded the threshold. Moreover, the radio base station 100A selects a radio communication terminal to which en MOB_BSHO_REQ message is to be transmitted. Here, we assume that the radio communication terminal 200B is selected as a destination to which the MOB_BSHO_REQ message is to be transmitted.

In Step S104, the radio base station 100A transmits the MOB_BSHO_REQ message to the radio communication terminal 200B.

In Step S105, the radio communication terminal 200B performs disconnection processing with the radio base station 100A in response to the MOB_BSHO_REQ message received in Step S104.

In Step S106, the radio communication terminal 200B performs reconnection processing with the radio base station 100B which is its handover destination. Specifically, the radio communication terminal 200B selects a handover destination radio base station from a previously-stored list of information on radio base stations which are handover destination candidates (neighbor list, for example).

In Step S107, the radio communication terminal 200B starts communication with the radio base station 100B.

### (5) Effects and Advantages

When the processing load on the CPU 130 exceeds the threshold, the radio base station 100A transmits an MOB_BSHO_REQ message that requests a handover to another radio base station (radio base station 100B), to the radio communication terminal 200B.

This allows the radio base station 100A to reduce the number of radio communication terminals to communicate with, when the processing load on the CPU 130 of the radio base station 100A exceeds the threshold. Accordingly, it is possible to more reliably prevent a deterioration of the communication capability of the radio base station 100A caused when the usage rate of the hardware resource of the radio base station 100A reaches a limit value.

Based on the ranging value table, the radio base station 100A selects a predetermined number (one in this embodiment) of radio communication terminals in order starting from the greatest ranging value. The radio base station 100A transmits an MOB_BSHO_REQ message to the radio communication terminal thus selected.

That is, the MOB_BSHO_REQ message is transmitted to the radio communication terminal 2003 that is located farthest from the radio base station 100A. Accordingly, having received the MOB_BSHO_REQ message and thus performed a handover to the radio base station 100E, the radio communication terminal 200E can continue its communication more stably.

Note that the ranging processing is general processing so executed at the time of establishing a connection, and thus the use of a result of this processing helps to prevent major changes in the configurations of the radio communication terminals and the radio base stations.

### Second Embodiment

In this embodiment, differences from the above-described first embodiment will be mainly described, and overlapping descriptions will be omitted.

### (1) Schematic Configuration of Radio Communication System

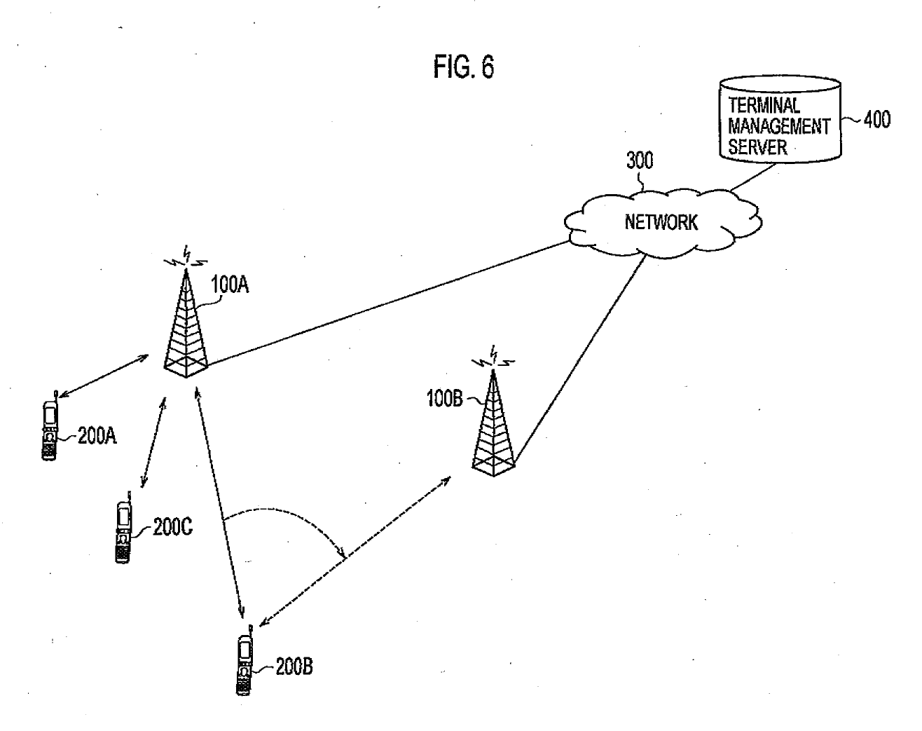

FIG. 6 is a schematic configuration diagram of a radio communication system according to this embodiment. As shown in FIG. 6, the radio communication system according to this embodiment is different from FIG. 1 in that it includes a terminal is management server 400 connected to the network 300.

The terminal management server 400 manages information on radio communication terminals (radio communication terminal 200A, radio communication terminal 200B, and radio communication terminal 200C) currently connected to radio base stations (radio base station 100A and radio base station 100B).

In this embodiment, the terminal management server 400 receives information on the radio communication terminal 200A, the radio communication terminal 200B, and the radio communication terminal 200C from the radio base station 100A, and stores the received information.

In addition, the terminal management server 400 stores the attribute of each radio communication terminal in advance. In this embodiment, the terminal management server 400 stores a service class table indicating information on a service class of each of the radio communication terminal 200A, the radio communication terminal 200B, and the radio communication terminal 200C.

The service class refers to a quality level (class) of a communication service provided to each radio communication terminal, and is determined based on contents of contract of the communication service for the radio communication terminal. Examples of a service class include a guaranteed class and a best effort class, as well as a high-rate-contract class and a low-rate-contract class, and the like.

### (2) Configuration of Radio Base Station

Next, a configuration of the radio base station 100A according to this embodiment will be described with reference to FIG. 3. The radio base station 100A according to this embodiment does not include the terminal information storage unit 142 shown in FIG. 3. Other parts of the configuration of the radio base station 100A are the same as that of FIG. 3.

In this embodiment, the ranging value table is stored in the terminal management server 400. The terminal selector 133 of the radio base station 100A acquires the service class table and the ranging value table from the terminal management server 400. The terminal selector 133 selects a radio communication terminal to which an MOB_BSHO_REQ message is to be transmitted, on the basis of the service class table and the ranging value table.

The terminal selector 133 does not select a radio communication terminal whose service class is high as a destination to which an MOB_BSHO_REQ message is to be transmitted, even if the radio communication terminal has a large ranging value (distant radio communication terminal).

Alternatively, from radio communication terminals of a low service class, the terminal selector 133 selects a radio communication terminal having a large ranging value, as a destination to which an MOB_BSHO_REQ message is to be transmitted.

Note that the terminal selector 133 may select a radio communication terminal to which an MOB_BSHO_REQ message is to be transmitted, by using only the service class table. In that case, the terminal selector 133 selects at least one radio communication terminal of a low service class as a destination radio communication terminal to which an MOB_BSHO_REQ message is to be transmitted.

### (3) Schematic Configuration of Terminal Management Server

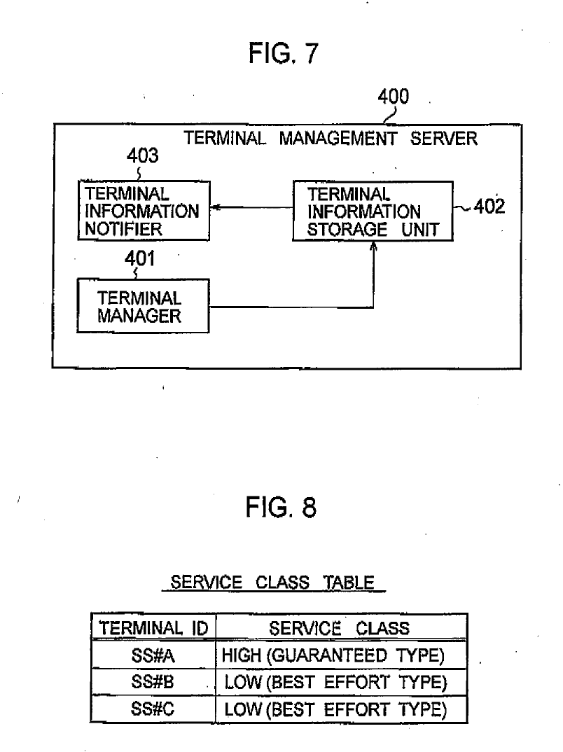

Next, a schematic configuration of the terminal management server 400 will be described. FIG. 7 is a schematic configuration diagram of the terminal management server 400.

As shown in FIG. 7, the terminal management server 400 includes a terminal manager 401, a terminal information storage unit 402, and a terminal information notifier 403.

The terminal manager 401 manages information on the radio so communication terminals (radio communication terminal 200A, radio communication terminal 200B, and radio communication terminal 200C) currently connected to the radio base stations (radio base station 100A and radio base station 100B).

The terminal information storage unit 402 stores the service class table and the ranging value table described above.

The terminal information notifier 403 notifies the radio base station 100A of the service class table and the ranging value table stored in the terminal information storage unit 402.

### (4) Example of Service Class Table

FIG. 8 shows an example of the service class table stored in the terminal information storage unit 402.

As shown in FIG. 8, the terminal information storage unit 402 stores the service class table in which terminal IDs each uniquely identifying a radio communication terminal (radio communication terminal 200A, radio communication terminal 200B, and radio communication terminal 200C) are associated respectively, with the service classes of the radio communication terminals.

In the example in FIG. 8, the terminal ID “SS#A” representing the radio communication terminal 200A is associated with a “high” service class. The terminal ID “SS#B” representing the radio communication terminal 200B is associated with a “low” service class. The terminal ID “SS#C” representing the radio communication terminal 200C is associated with a “low” service so class.

### (5) Operation of Radio Communication System

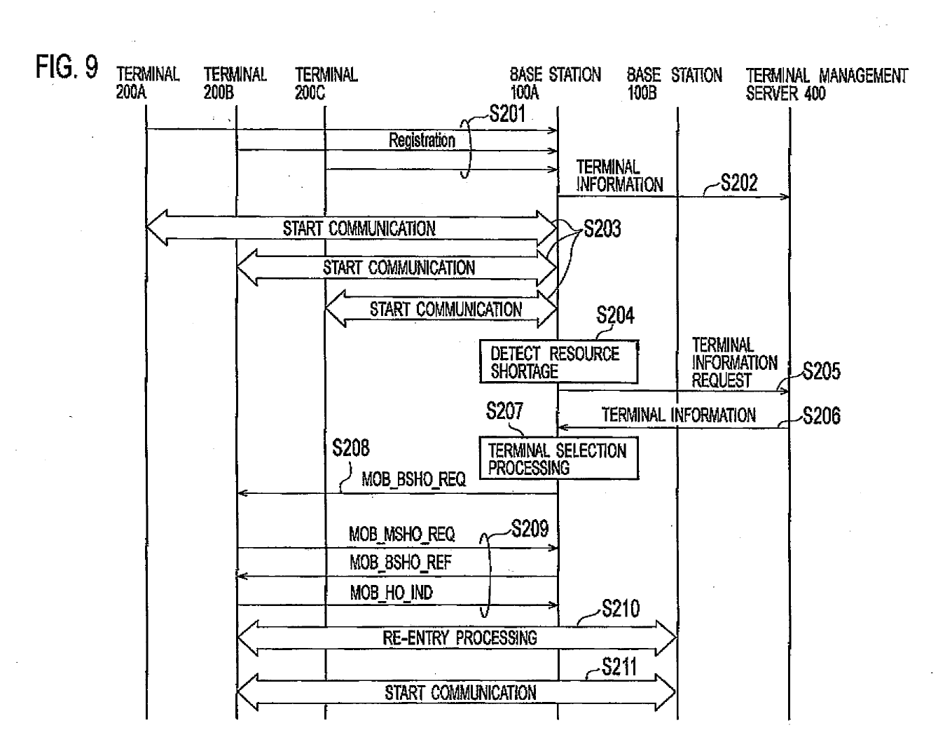

Next, an operation of the radio communication system according to this embodiment will be described. FIG. 9 is a sequence diagram showing the operation of the radio communication system according to this embodiment.

In Step S201, each of the radio communication terminal 200A, the radio communication terminal 200B, and the radio communication terminal 200C establishes a connection to the radio base station 100A.

In Step S202, the radio base station 100A registers ranging value information acquired in Step S201 to the terminal management is server 400.

In Step S203, each of the radio communication terminal 200A, the radio communication terminal 200B, and the radio communication terminal 200C starts communication with the radio base station 100A.

In Step S204, the radio base station 100A detects a resource shortage by using the above-described method.

Through Step S205 to Step S206, the radio base station 100A acquires the ranging value information and service class information from the terminal management server 400.

In Step S207, the radio base station 100A selects a radio communication terminal to which an MOB_BSHO_REQ message is to be transmitted, on the basis of the ranging value information and the service class information acquired in Step S206. Here, we assume that the radio communication terminal 200B is selected.

Note that the terminal management server 400 may select a radio communication terminal to which an MOB_BSHO_REQ message is to be transmitted, and the radio base station 100A may receive a result of the selection from the terminal management server 400.

In Step S208, the radio base station 100A transmits the MOB_BSHO_REQ message to the radio communication terminal 200B.

In Step S209, the radio communication terminal 200B performs disconnection processing with the radio base station 100A in response to the MOB_BSHO_REQ message received in Step S204.

In Step S210, the radio communication terminal 200B performs reconnection processing with the radio base station 100E which is its handover destination.

In Step S211, the radio communication terminal 200B starts communication with the radio base station 100B.

### (6) Effects and Advantages

In this embodiment, the radio base station 100A selects a radio communication terminal to which an MOB_BSHO_REQ message is to be transmitted, on the basis of the service class table in addition to the ranging value table. This allows a radio communication terminal of a high service class to continue its communication stably.

### Other Embodiments

Hereinabove, the present invention has been described by using the first and second embodiments. However, it should not be understood that any of the descriptions and the drawings which form part of this disclosure limits the present invention. Various alternative embodiments, examples, and operation techniques should be apparent to those skilled in the art from the disclosure.

In the first and second embodiments described above, an example is described in which the processing load on the CPU 130 is judged. However, what is to be judged is not limited to the processing load on the CPU 130, and may be the usage rate of the memory 140 or the usage rate of a channel assigned to a radio communication terminal.

Moreover, in the first and second embodiments described above, an example is described in which a radio communication terminal to which an MOB_BSHO_REQ message is to be transmitted is selected based on the ranging values and the service classes. However, what is to be based on for selecting a radio communication terminal to which an MOB_BSHO_REQ message is to be transmitted, is not limited to the ranging values and the service classes, and may be priority information (QoS) indicating priorities respectively corresponding to types of communication performed by the radio communication terminals. That is, an MOB_BSHO_REQ message is transmitted to at least one radio communication terminal having a low QoS value.

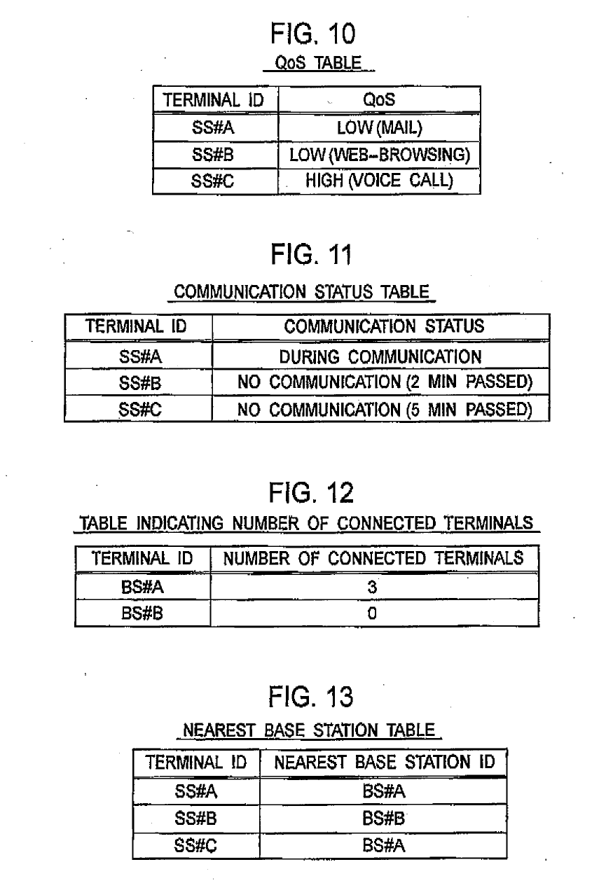

In this case, the radio base station 100A or the terminal management server 400 stores a QoS table as shown in FIG. 10. The QoS table is a table in which the terminal IDs are respectively associated with QoS values. In the example shown in FIG. 10, a higher QoS value is set for an application requiring higher realtimeness. Specifically, the terminal ID “SS#A” representing the radio communication terminal 200A executing mail tasks is associated with a “low” QoS value. The terminal ID “SS#B” representing the radio communication terminal 200B performing web-browsing is associated with a “low” QoS value. The terminal ID “SS#C” representing the radio communication terminal 200C performing a voice call is associated with a “high” QoS value.

Moreover, a radio communication terminal to which an MOB_BSHO_REQ message is to be transmitted may be selected in accordance with the communication status of each radio communication terminal. Specifically, an MOB_BSHO_REQ message is transmitted to at least one radio communication terminal left for a long period of time since its communication is terminated.

In this case, the radio base station 100A or the terminal management server 400 stores a communication status table as shown in FIG. 11. The communication status table is a table in which the terminal IDs are respectively associated with the communication statuses. The terminal ID “SS#A” representing the radio communication terminal 200A is associated with a communication status “currently communicating.” The terminal ID “SS#B” representing the radio communication terminal 200B is associated with a communication status “2 minutes passed since so communication is terminated.” The terminal ID “SS#C” representing the radio communication terminal 200C is associated with a communication status “2 minutes passed since communication is terminated.”

Note that the radio base station 100A or the terminal management server 400 may select a radio communication terminal to which an MOB_BSHO_REQ message is to be transmitted, by using combinations of the ranging value, the service class, the QoS value, and the communication status.

In the above-described embodiments, the radio base station 100A does not particularly designate a handover destination radio base station for the radio communication terminal 200B, but may actually designate a handover-destination radio base station. Specifically, the radio base station 100A transmits a base station In identifying a handover destination radio base station, together with an MOS_BSHO_REQ message.

The radio base station 100A or the terminal management server 400 selects a handover destination radio base station. For a method of selecting a handover-destination radio base station, the following method (a) or (b) may be used, for example.

(a): The terminal management server 400 selects a radio base station having a fewer number of radio communication terminals that are currently connected thereto, as a handover-destination radio base station. Then, the terminal management server 400 notifies the radio base station 100A of a result of the selection. In this case, the terminal management server 400 receives a report of the number of currently connected radio communication terminals from each radio base station, and then creates and stores a table indicating the number of connected terminals as shown in FIG. 12.

In the example shown in FIG. 12, a base station ID “BS#A” representing the radio base station 100A is associated with the number of connected terminals “3,” A base station ID “BS#B” representing the radio base station 100B is associated with the number of connected terminals “0.”

Note that the terminal management server 400 may manage the load (processing load on CPU) on each radio communication terminal, and select a handover destination radio base station on the basis of the load.

(b): The terminal management server 400 selects the nearest base station as a handover destination radio base station, the nearest base station being a radio base station located right close to a radio communication terminal to which an MOB_BSHO_REQ message is to be transmitted. The terminal management server 400 then notifies the radio base station 100A of a result of the selection.

Specifically, each radio communication terminal registers its positional information measured by a GPS installed therein, to the terminal management server 400. The terminal management server 400 compares the positional information of the radio communication terminals with the positional information of the radio base stations, and creates and stores a nearest base station table as shown in FIG. 13.

In the example shown in FIG. 13, the terminal ID “SS#A” representing the radio communication terminal 200A is associated with a nearest base station ID “BS#A.” The terminal ID “SS#B” representing the radio communication terminal 200B is associated with a nearest base station ID “BS#B.” The terminal ID “SS#C” representing the radio communication terminal 200C is associated with the nearest base station ID “BS#A.”

In the above-described embodiments, a radio communication system based on mobile WiMAX (IEEE802.16e-2005 standard) has been described. However, the radio communication system is not limited to one based on mobile WiMAX. The present invention may be applied to other radio communication systems such as the UMB (Ultra Mobile Broadband) which is a standard currently being formulated in 3GPP2, and the LTE (Long Term. Evolution) which is a standard currently being formulated in 3GPP.

As described above, it should be understood that the present invention includes various embodiments and the like which are not described herein. Hence, the present invention is limited only by the features of the present invention according to the scope of claims appropriate for this disclosure.

Note that the entire content of Japanese Patent Application No. 2007-82861 (filed on Mar. 27, 2007) is incorporated herein by reference.

### INDUSTRIAL APPLICABILITY

The present invention makes it possible to more reliably so prevent a deterioration of the communication capability caused when the usage rate of a hardware resource of a radio base station reaches a limit value, and thus is useful for radio communication such as mobile communication.

1. A radio base station that communicates with radio communication terminals, comprising:
an acquiring unit configured to acquire communication capability information while the radio base station is connected to the radio communication terminals, the communication capability information indicating a capability to communicate with the radio communication terminals;
a judging unit configured to judge whether or not the communication capability information acquired by the acquiring unit falls below a threshold; and
a transmitter configured to transmit a switching request to at least one of the radio communication terminals if the judging is unit judges that the communication capability information falls below the threshold, the switching request requesting switching of a connection destination to a different radio base station.

2. The radio base station according to claim 1, further comprising:
a corrector configured to correct a timing at which a radio signal is transmitted from each of the radio communication terminals and a timing at which a radio signal is transmitted to each of the radio communication terminals; and
a selector configured to select a predetermined number of the radio communication terminals in order starting from the greatest value of correction amounts of timings, on the basis of a table in which each of the radio communication terminals is associated with each of the correction amounts of the timings, wherein
the transmitter transmits the switching request to each of the radio communication terminals selected by the selector.

3. The radio base station according to claim 1, further comprising
a selector configured, to select a predetermined number of the radio communication terminals in order starting from the smallest value of service quality information, on the basis of a table in which each of the radio communication terminals is associated with the service quality information indicating quality of a communication service provided to each of the radio communication terminals, wherein
the transmitter transmits the switching request to each of the radio communication terminals selected by the selector.

4. The radio base station according to claim 1, further comprising
a selector configured to select a predetermined number of the radio communication terminals in order starting from the smallest value of priority information, on the basis of a table in which each of the radio communication terminals is associated with the priority information indicating a priority corresponding to a type of communication performed by each of the radio communication terminals, wherein
the transmitter transmits the switching request to each of the radio communication terminals selected by the selector.

5. The radio base station according to claim 1, further comprising
a selector configured to select a predetermined number of the radio communication terminals in order starting from the greatest value of lengths of time elapsed after each of the radio communication terminals terminates its communication, on the basis of a table in which each of the radio communication terminal is associated with each of the lengths of time elapsed, wherein
the transmitter transmits the switching request to each of the radio communication terminals selected by the selector.

6. The radio base station according to any one of claims 2 to 5, further comprising
a communication unit configured to communicate with a terminal management server that manages the radio communication terminals, wherein
the table is stored in the terminal management server.

7. The radio base station according to claim 6, wherein
the communication unit receives base station identifying information identifying the different radio base station, from the terminal management server, and
the transmitter transmits the switching request including the base station identifying information.

8. A radio communication method for a radio base station that communicates with radio communication terminals, comprising the steps of:
acquiring communication capability information while the radio base station is connected to the radio communication, terminals, the communication capability information indicating a capability to communicate with the radio communication terminals;
judging whether or not the communication capability information acquired in an acquisition step falls below a threshold; and
transmitting a switching request to at least one of the radio communication terminals if it is judged in a judging step that the communication, capability information falls below the threshold, the switching request requesting switching of a connection destination to a different radio base station.
